(19) United States
(12) Patent Application Publication
(10) Pub. No.: US 2013/0136828 A1
(43) Pub. Date: May 30, 2013

(54) PROCESS FOR REALISING A TUBULAR SUPPORT, A CAPSULE FOR PREPARATION OF BEVERAGES INCORPORATING THE TUBULAR SUPPORT AND A PRODUCTION METHOD OF THE CAPSULE

(71) Applicant: NOVACART S.P.A., GARBAGNATE MONASTERO (LECCO) (IT)

(72) Inventor: GIANMARIO ANGHILERI, MALGRATE (IT)

(73) Assignee: NOVACART S.P.A., GARBAGNATE MONASTERO (LECCO) (IT)

(21) Appl. No.: 13/684,323

(22) Filed: Nov. 23, 2012

(30) Foreign Application Priority Data
Nov. 25, 2011 (IT) MI2011A002157

(51) Int. Cl. B65D 85/804; B31B 3/00

(52) U.S. Cl. CPC B65D 85/8043; B31B 3/00
USPC 426/112; 53/456

(57) ABSTRACT

A capsule has been realised for preparing beverages, in particular coffee, in which a filter container exhibits a base and a lateral wall that define a housing cavity for the foodstuff substance (15). A tubular support (2) is defined between an upper opening (17) and a lower opening (18), and houses the filter container internally thereof. A predetermined quantity of the substance (15) is housed internally of the housing compartment (16) and the housing compartment (16) is hermetically closed by a closing film.

The present description relates to a capsule for preparation of beverages, in particular foodstuff beverages, and to a production process thereof. In particular, the main field of application is the preparation of coffee, such as American-style “long” coffee, although it could be used for preparing other types of drinks, such as cappuccino, chocolate, fruit juices or other drinks, in general, though not necessarily, of nutritional quality.

The description further relates to a method for producing a tubular support made of paper material to be used with the capsule.

### BACKGROUND

As is known, recent years have seen rapid establishment and wide use of coffee-making machines, starting with pods or capsules containing appropriate blends of coffee in powder form.

In particular, the capsule is inserted in a seating in the dispensing machine, which pierces the capsule at an upper surface and a lower surface thereof so that the water can cross the coffee mixture and the coffee is dispensed at a spout of the machine.

From the structural point of view, capsules are in general constituted by a container casing made of plastic or aluminium, and are destined to contain the powdered coffee and superiorly closed by an appropriate plastic or aluminium film.

A further type of these capsules, for example described in US 2001048957 is constituted by an external casing made of plastic material, such as polystyrene, exhibiting a circular bottom wall and a trunco-conical lateral wall, emerging from the bottom wall such as to define a containing cavity.

A further container made of paper material is constrained to an upper opening, which further container is destined to contain the powdered coffee.

In particular, the second container is made of filter paper and is entirety contained internally of the first container.

The engagement is attained at an upper portion of the lateral wall of the plastic external container and the internal paper container, which are therefore constrained at the upper portion.

The inlet opening, which substantially coincides for both containers, is closed by means of a special aluminium film.

During dispensing, a rigid punch pierces the aluminium film and injects water at a high temperature into the containing zone of the coffee; the filter paper enables passage of the water crossing the walls, once it has absorbed the coffee flavour.

A further punch pierces the base wall of the plastic container, enabling exit of the drink towards the collection zone of the machine.

Though the prior art, briefly described above, is in great use in the field of preparation of longer-style American coffee, which requires no injection of water into the capsule at pressures above ambient pressure, it exhibits some drawbacks and/or operational limits.

Firstly, the above-described capsule is constituted by a plurality of heterogeneous materials which make the remains of the product difficult to dispose of.

The above point acquires greater relevance when considering the high consumption of capsules which, once used, are destined for elimination as a solid urban refuse, as they cannot be easily recycled, even those parts that are in themselves entirely biodegradable.

Further, the capsule is especially unwieldy, in particular with regard to the longitudinal development thereof, which leads to handling and transport costs that are not insignificant, given the large number of capsules distributed.

Further, the special configuration requires the presence of special and adequate piercing systems for correct injection of boiling water and for collection thereof.

Lastly, the technical solutions for the coupling of the various parts to one another, while being at the forefront of the technology, have been observed to be quite complex and improvable in various ways.

### SUMMARY

The aim of the present embodiments, described herein, is principally to obviate one or more of the drawbacks and the operating limits defined in the foregoing.

A first aim of one or more of the embodiments of the capsule illustrated in the following is to provide a product that is completely or nearly completely biodegradable and therefore easily destinable to recycling operations.

A further aim is to provide a product that can be reduced to compost, with the consequent advantages in terms of eco-compatibility.

A further aim of one or more of the illustrated embodiments is to enable a reduction of the volumes of the capsule, especially as regards transport and storage before use.

A still further aim of one or more of the embodiments illustrated in the following is to provide a production process that is particularly advantageous and automatable, thus reducing, as far as possible, the production stations present in the line and the manufacturing steps actuated thereafter.

A further aim is to provide a tubular support made of a paper material with an innovative process which enables optimal sealability of the capsule.

One or more of the above-described objectives is substantially attained by the embodiments of the capsule as described in the following.

In a first independent aspect, a process is disclosed for realising a tubular support (2) made of a paper material, in particular suitable for realising a capsule for preparation of drinks, comprising following steps: predisposing a flat blank (100) of paper material having a body (10) delimited by a plurality of sides (102a), (102b), (102c), (102d), (102e), (102f) and exhibiting two opposite lateral portions (103a), (103b), each located at a respective side (102c), (102d); three-dimensionally deforming the flat blank such as to define a tubular semi-finished workpiece (200) exhibiting the two lateral portions (103a), (103b) neared to one another; the tubular semi-finished workpiece (200) exhibiting a tubular conduit which extends between an upper opening (201) delimited by a free upper edge (202) corresponding to a side (102a) of the sides of the blank (100) and a lower opening (203) delimited by a lower free edge (204) corresponding to a further side (102b) of the sides of the blank (100); coupling the two lateral portions to one another, the body (101) defining a lateral wall (205) of the tubular semi-finished workpiece (200); deforming the free upper edge (202) towards the outside of the upper opening (201) such as to define a curl (206) which extends perimetrally about the upper opening (201) of the semi-finished workpiece (200); crushing the curl (206) in a plane such as to define an annular crown (6) which radially emerges from an upper opening (17) of the tubular support (2), the annular crown (6) exhibiting an upper surface (6a) that is flat, smooth and free of pleats.

In a second aspect according to the preceding aspect, the step of predisposing the blank (100) comprises a sub-step of predisposing a blank made of stretchable paper having a stretchability in a prefixed direction (D) by at least 5% or more, and in particular at least 8% or more, for example the stretchable paper being able to stretch in a direction (D) by at least 8%, in particular at least 10%, and in the perpendicular direction (T) to the direction (D) by at least 10%, in particular at least 13%.

In a 3rd aspect according to any one of the preceding aspects, the step of predisposing the blank (100) comprises a step of defining a direction of maximum stretchability (D) of the paper in a transversal direction that is substantially perpendicular to the side (102a) of the blank destined to define the free upper edge (202) of the semi-finished workpiece (200).

In a 4th aspect according to any one of the preceding aspects, the body of the blank (100) is delimited by four main sides (102a), (102b), (102c), (102d), the side (102a) being destined to define the free upper side (202) of the semi-finished workpiece (200) having a curved profile with a concavity facing towards the inside of the body (101).

In a 5th aspect according to any one of the preceding aspects, the step of deforming the free upper edge (202) for deforming a curl (206) comprises a fold towards an outside by a quantity of material that is such as to enable defining an annular crown (6) having a breadth (1) of the free upper surface (6a) which is at least 3 mm, in particular at least 4 mm.

In a 6th aspect according to any one of the preceding aspects, the definition of the annular crown (6) comprises defining an upper wall (21) and a lower wall (22) folded below the upper wall, the two walls (21, 22) being defined in a single piece.

In a 7th aspect according to any one of the preceding aspects, a capsule is provided for preparing beverages such as coffee or the like, comprising: a filter container (3) exhibiting a base and a lateral wall (7) emerging distancingly from the base (9), the filter container (3) exhibiting an upper access and defining a housing compartment (16) being made of a material that is at least partially permeable to a liquid; at least a tubular support (2), exhibiting a tubular conduit which extends between an upper opening (17) and a lower opening (18), the filter container (3) being housed at least in part internally of the tubular conduit, in coupling conditions between the filter container and the tubular support (2), the filter container receiving and retaining, in the housing compartment, the material in inlet through the upper opening (17) of the tubular support; a predetermined quantity of a substance (15) suitable for releasing a flavour for preparing a drink when crossed by a liquid, the substance (15) being housed in the housing compartment (16), and a closing film (4) engaged to the filter container (3) and/or the tubular support (2) for closing the upper access of the filter container (3) and/or the upper opening (17) of the tubular support such as to prevent exit of the material contained in the housing compartment (16).

In an 8th aspect according to the preceding aspect, the tubular support (2) exhibits, at the upper opening (17), an annular crown (6) emerging distancingly from a lateral wall (5), in particular in a radially external direction with respect to the tubular conduit delimited by the upper opening (17) and the lower opening (18), the annular crown (6) exhibiting an upper surface (6a) that is substantially flat.

In a 9th aspect according to the preceding aspect 7 or 8, the tubular support (2) exhibits a cylindrical symmetry, the upper opening (17) being circular, optionally the lower opening (17) being circular, still more in particular the upper opening (17) having a greater area than the areas of the lower surface (18), for example the diameter of the upper opening (17) being greater than the diameter of the lower opening (18).

In a 10th aspect according to the preceding aspect 7, 8 or 9, the tubular support (2) exhibits a lateral wall (5) conformed as a truncated cone having a decreasing section starting from the upper opening (17) towards the lower opening (18).

In an 11th aspect according to the preceding aspect 7, 8, 9 or 10, the tubular support is made of a plastic material by moulding, in particular it is made in a single piece.

In a 12th aspect according to the preceding aspect 7, 8, 9, 10 or 11, the lower opening (18) of the tubular support (2) exhibits dimensions alike to the dimensions of the base (9) of the filter container (3).

In a 13th aspect according to the preceding aspect 7, 8, 9, 10, 11 or 12, in a condition of reciprocal engagement, a lateral wall (5) of the tubular support (2) and the lateral wall (7) of the filter container (3) develop adjacently, the lateral wall (7) of the filter container (3) being in contact with the lateral wall (5) of the tubular support (2) at the upper opening (17) thereof, in particular the lateral wall (7) of the filter container (3) distancing from the lateral wall (5) of the tubular support (3), as it progresses from the upper opening (17) towards the lower opening (18).

In a 14th aspect according to the preceding aspect 7, 8, 9, 10, 11, 12 or 13, the tubular support (2) is made of a paper material.

In a 15th aspect according to the preceding aspect 7, 8, 9, 10, 11, 12, 13 or 14, the tubular support (2) is made by deep-drawing starting from a flat sheet, the lateral wall (5) and the annular crown (6) exhibiting a predetermined number of pleats (12) defined by the excess of material.

In a 16th aspect according to the preceding aspect 7, 8, 9, 10, 11, 12, 13, 14 or 15, the tubular support (2) comprises at least a body (20) defining a lateral wall (5) and a plurality of teeth (14) emerging radially from the lateral wall (5) and a stiffening ring (13) in a separate body and unremovably coupled to the body (20); in particular the stiffening ring (13) is coupled by superposing on the teeth (14).

In a 17th aspect according to the preceding aspect, the body (20) exhibits a closing strip (11) developing along the lateral wall (5) from the upper opening (17) to the lower opening (18).

In an 18th aspect according to the preceding aspect 7, 8, 9, 10, 11, 12, 13, 14, 15, 16 or 17, the closing element (4) is a film made of a bio-degradable plastic such as MATER-BI.

In a 19th aspect according to the preceding aspect 7, 8, 9, 10, 11, 12, 13, 14, 15, 16, 17 or 18, the closing film is coupled by welding and sealedly to the annular crown (6) of the tubular support (2) and/or to the upper crown (8) of the filter container (3).

Further characteristics and advantages will more fully emerge in detail during the description of embodiments of the capsule and the relative production process, according to one or more of the accompanying claims.

### BRIEF DESCRIPTION OF THE DRAWINGS

The description will be made in the following with reference to the accompanying figures, which are provided by way of non-limiting example, and in which:

FIG. 1 illustrates a complete capsule for the preparation of comestible beverages, in accordance what is described below;

FIG. 2 illustrates the capsule of FIG. 1 with the upper film partially removed;

FIG. 3 shows the capsule of FIG. 1 in an exploded view;

FIG. 4 shows the capsule of FIG. 1 in section with a vertical plane;

FIG. 4A shows a detail of FIG. 4 in larger scale;

FIG. 5 shows the external support of the capsule of FIG. 1 in a first embodiment;

FIG. 6 shows a section along a vertical plane of the external support of FIG. 5;

FIGS. 7A and 7B show a second embodiment of the external support of FIG. 1 in perspective view respectively from above and below;

FIG. 8 is a section view of the external support of FIG. 7A;

FIG. 9 shows the development in plan view of the components constituting the external support of FIG. 8;

FIG. 10 illustrates an external support in a further embodiment;

FIG. 11 shows the support illustrated in FIG. 10 in section along a vertical plane;

FIG. 12 shows the development in plan view of the support of the previous figure;

FIG. 13 is a block diagram illustrating the manufacturing steps of the capsule of FIG. 1;

FIG. 14 shows a specific embodiment of the production phase and coupling of the inner container in filter paper to external media;

FIGS. 15A and 15B show two further embodiments of the external media,

FIGS. 16-20 show successive stages of a method of making a tubular support sheet material and the capsule thus obtained; and

FIGS. 21-25 show successive stages of a method of making a support sheet material and the capsule thus obtained in a different embodiment.

### DETAILED DESCRIPTION

With reference to the accompanying figures, 1 denotes in its entirety a capsule for the preparation of beverages, in particular foodstuff beverages such as coffee, cappuccino, chocolate, fruit juices or the like.

In particular, the capsule described below in some of its possible embodiments of exemplary nature lends itself primarily to the preparation of coffee, and more in detail the preparation of the so-called American coffee, or a more diluted drink obtained by percolation using very hot water (between 90° and 100° for example) at ambient pressure or substantially ambient pressure passing through the blend of coffee powder.

Obviously the capsule can also be used for the preparation of any other beverage that can be obtained by passing hot liquid through a substance suitable for releasing a flavour to the liquid.

In other words, the capsule of the description could be used for the preparation of beverages such as cappuccino, chocolate, milk, fruit juices or others besides, according to the content thereof.

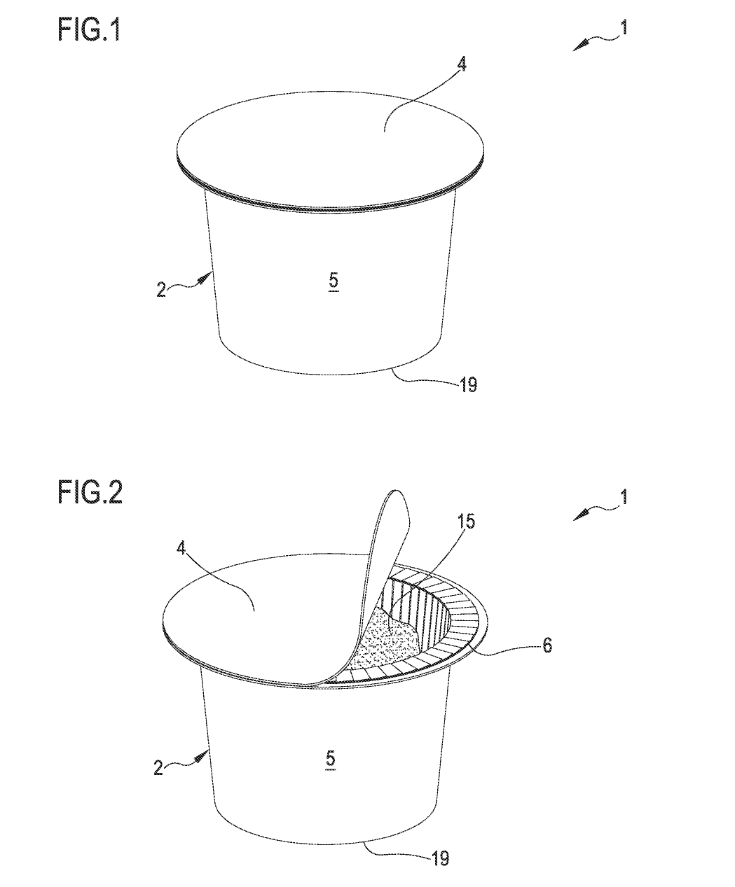

From the general point of view the complete capsule, shown in FIGS. 1, 2 and 3 is essentially constituted by a support 2, a filter container 3 coupled to the tubular support 2, the foodstuff substance 15 contained in the filter container 3 and the closing element 4 sealing the filter container 3.

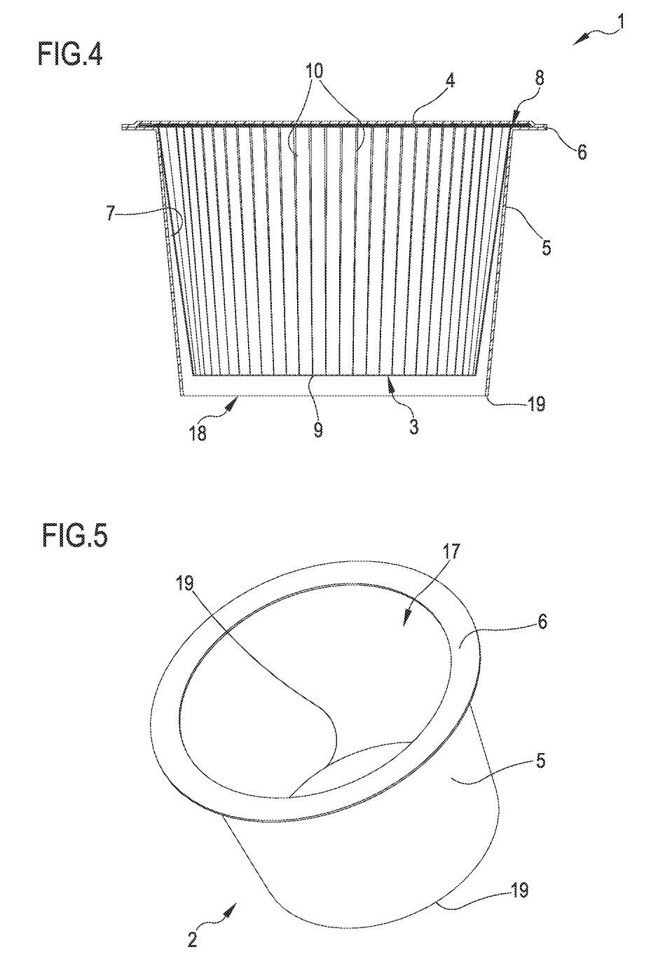

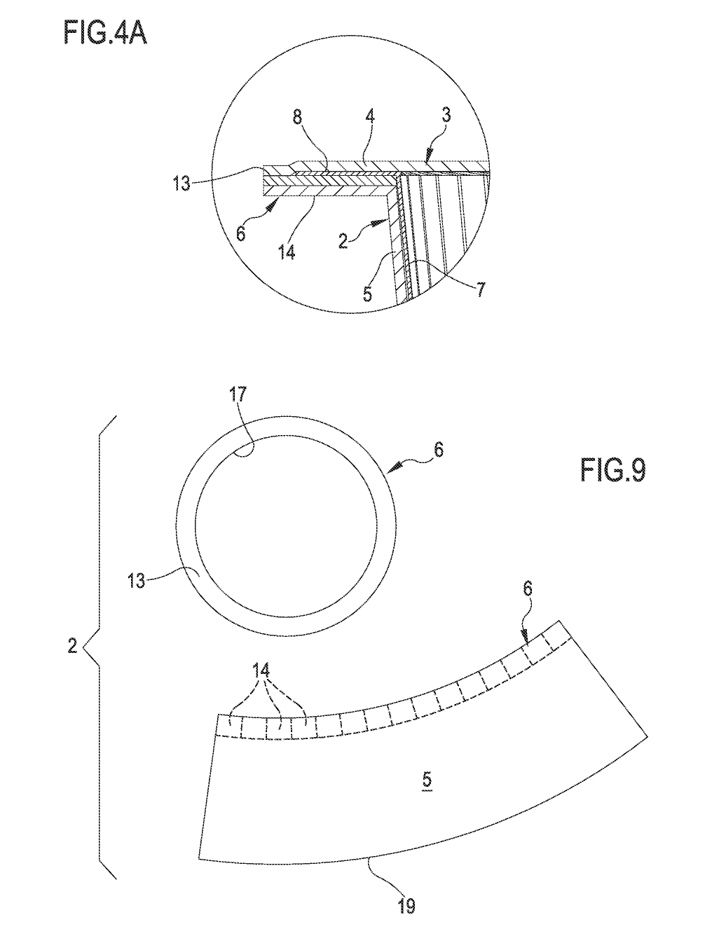

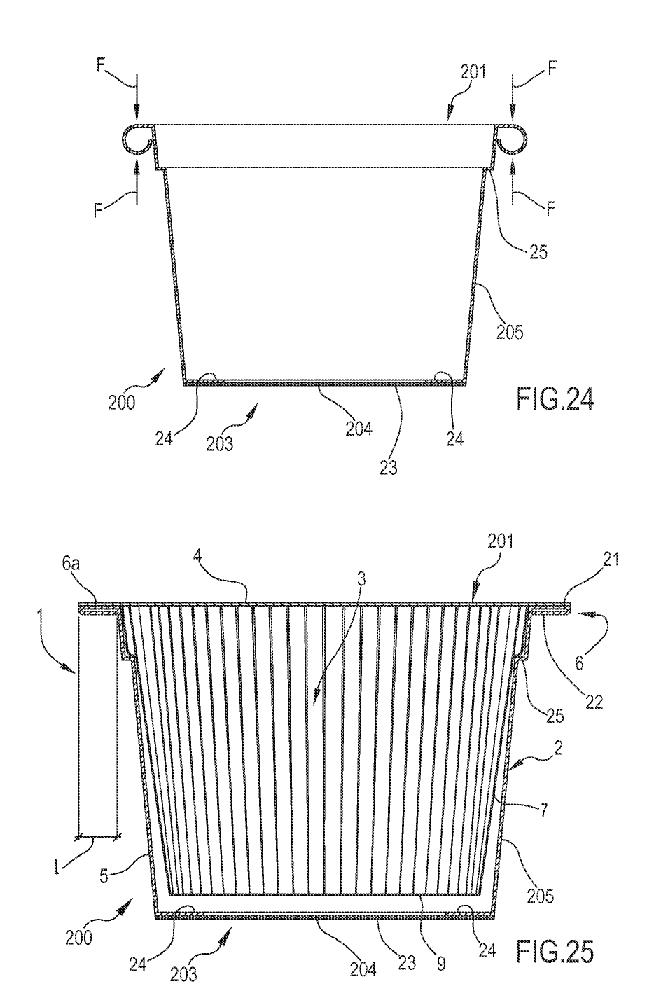

As it is apparent from the following description, the support 2 might be a tubular support as in FIGS. 4, 5, 6, 7a, 7b, 8, 10, 11, 15a, 15b, 19 and 20 or a support inferiorly closed by a base 23 thereby defining a container, such as a container; see FIGS. 24 and 25.

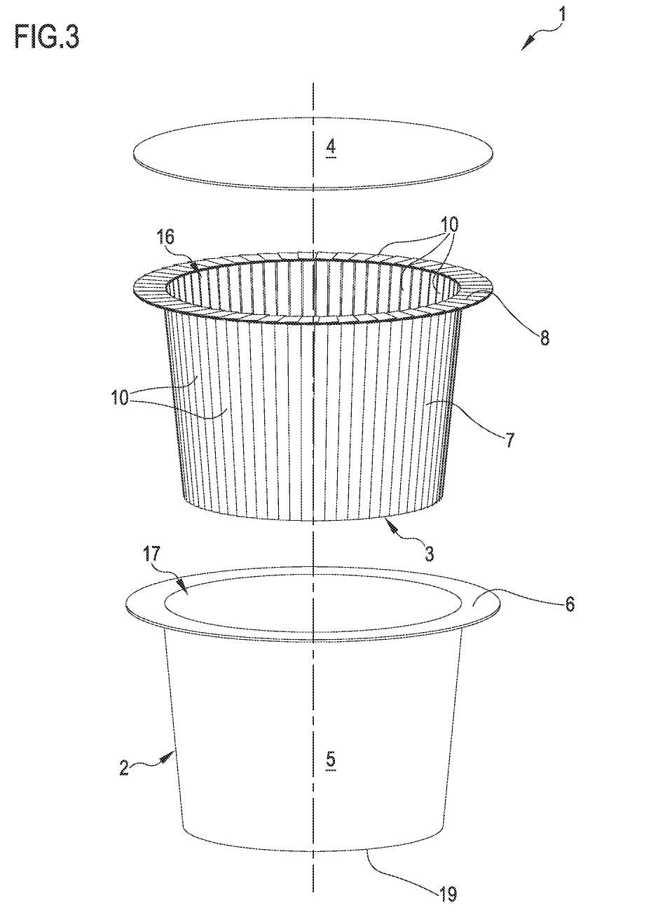

Examining in particular FIG. 3, which shows the capsule in an exploded view to illustrate the various components and FIG. 4 which shows a section along a vertical plane, primarily it can be noted that the filter container 3 exhibits a base 9 from which a lateral wall 7 emerges in a distancing direction, which base 9 and lateral wall 7 define, in cooperation, a housing compartment 16 suitable for releasing the substance which will release a flavour during preparation of the beverage.

In particular, the filter container also presents an annular upper crown portion 8 emerging radially from the lateral wall 7 in the opposite position with respect to the base 9.

In particular, this upper crown 8 lies in a same plane which is substantially parallel to the plane of the base 9.

Still observing from the geometrical point of view the filter container 3 exhibits a truncoconical shape with the lateral wall 7 inclined relative to the perpendicular to the base, thus defining a top access to the compartment 16 having a larger plan than the base.

Therefore, in cross section the lateral wall 7 is inclined at an angle α of between 0° and 15° relative to a vertical axis perpendicular to the base 9.

The filter container may also assume a substantially cylindrical shape with the lateral wall 7 emerging perpendicular from the base 9.

The base 9 is circular in shape, as is the top access to the housing compartment 16.

The upper crown 8 emerges radially distancingly from the axis of symmetry of the cylindrical filter container, moving in an outwards direction.

The filter container 3 is made of a material at least partially permeable to a liquid (particularly water) and is configured, as mentioned, such as to receive and retain the substance in inlet through the upper access in the housing compartment.

In particular, the filter container 3 is configured to allow the entry of a liquid into the interior thereof, allow an interaction with the substance contained in the housing compartment 16 and then permit the egress of the liquid plus the flavour released from the substance through at least a portion thereof.

In general terms, the entire filter container 3 will be made of a material permeable to the liquid in such a way that the liquid, once it has been flavoured with the substance, can escape primarily by gravity from the filter container 3 itself.

In general, the filter container will be made of biodegradable material such as a suitable filter paper.

From the manufacturing point of view the filter container in single piece is profiled (for example deep-drawn) starting from a flat sheet material.

The flat blank, typically circular in shape, is deformed by drawing, to define the base 9, the lateral wall 7 and the upper crown 8.

Therefore, as a result of the manufacturing process, the filter container 3 will present a plurality of pleats 10 in the lateral wall 7 and the upper crown 8 that are generated due to the excess of material made available during the deformation of the flat blank into three dimensions.

It is obvious that these pleats 10 can be generated step in a more or less controlled way during the drawing operation in order that they can be arranged, for example, in a substantially regular manner along the lateral wall 7 (and along the upper crown 8).

Obviously, the nature of the material constituting the filter container 3 determines the quality deep-drawing and/or the regularity of the pleats 10 described above.

In general, following this deep-drawing operation the filter container 3 will exhibit, in a section along a parallel plane to the base plane, a lateral wall 7 having a substantially circular profile with a plurality of superposing sections of material developing in a Z-shape and alternated with a plurality of sections consisting of a line (i.e. by the single sheet material forming the container).

The filter container of FIG. 25 may be identical to the previously described filter container or may not present the upper crown 8.

Proceeding to examining the components of the capsule for the preparation of beverages, the capsule according to first embodiments (FIGS. 4 to 20) makes use of a tubular support (i.e. a support having upper and lower openings 17, 19 when in use).

Indeed the capsule further comprises the above-mentioned tubular support 2 which internally defines a tubular conduit (i.e. open superiorly and inferiorly) which extends between an upper opening 17 and a lower opening 18.

The tubular support 2 exhibits, at the upper opening 17 thereof, an annular crown 6 emerging distancingly from the lateral wall 5, in particular in a radially external direction with respect to the tubular conduit delimited by the upper 17 and lower openings 18.

The upper surface 6a of the annular crown 6 is substantially flat.

In general the lateral wall 5 of the tubular conduit also exhibits a flared shape with larger dimensions at the upper opening 17 of the tubular support 2.

In general, in section along a parallel plane to the axis of development of the vertical tubular conduit, the lateral wall 5 is inclined so that the upper opening at the access 17 is larger than the lower opening at the access 18.

The inclination of the lateral wall is between 0° and 15° relative to the axis of the tubular conduit itself.

In general the tubular support 2 will also be truncoconical with a circular upper opening at the access 17.

Conversely, the lower opening formed at the access 18 can be circular, but it could also have a different shape.

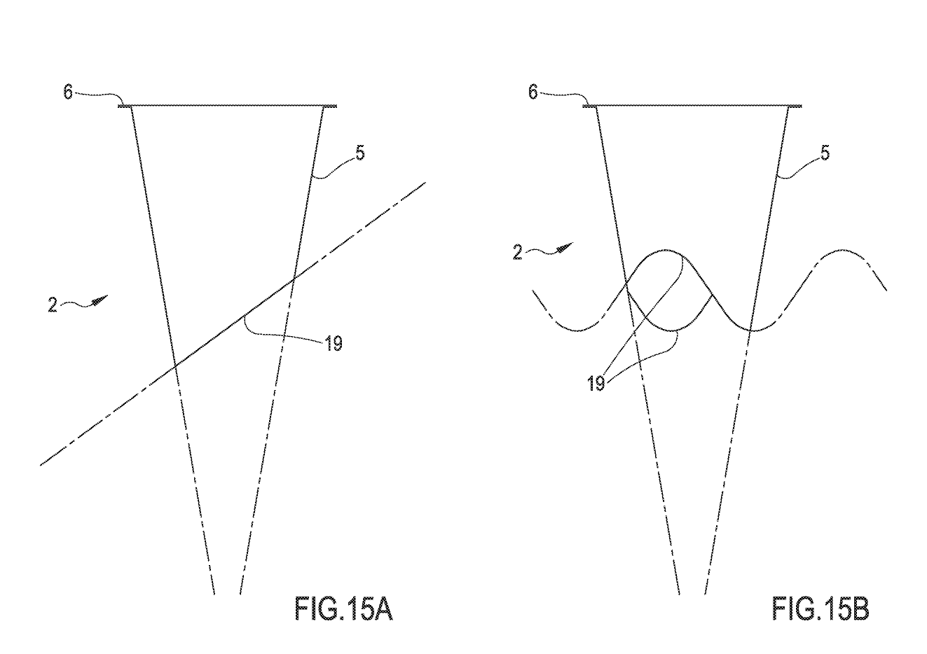

In fact, given an overall conical shape of the tubular support (see for instance the diagram of FIG. 15A or 15B), the lower access 18 could be defined by cutting the cone at an inclined plane with respect to the axis of development of the support, so that in side view the tubular support 2 exhibits a more pointed lateral wall 5 with a development zone in a downwards direction that is slightly greater than the diametrically opposite zone (FIG. 15A).

Of course the imaginary cone development can be cut by the variously-inclined walls, or even by different profiles, without forsaking the concept described in the following (FIG. 15B).

Though the presence of a portion of bottom wall is possible, i.e. portions of material which extend transversally to the direction of the lateral wall 5 at the lower access 18, in the tubular support capsule embodiment generally no reinforcement or annular ring will be present and in fact the upper access 17 will be delimited by the lower edge 19 of the lateral wall.

The tubular support 2 also consists of a wall made of a sheet material having a contained section, generally less than 5 mm and in particular less than 3 mm.

From the manufacturing point of view the tubular support 2 can be obtained by moulding, for example injection-moulding, made of a plastic material such as to define a single rigid support body for the filter container 3.

An embodiment of this type is illustrated in FIGS. 4, 5 and 6.

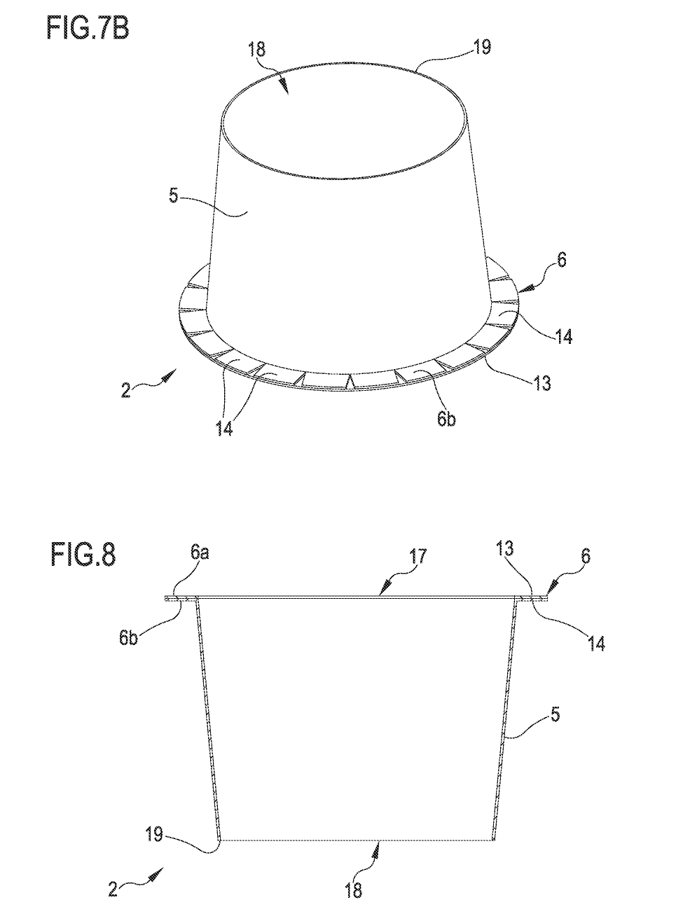

An alternative embodiment (and in general preferred to the previous one) of the tubular support 2 is shown in FIGS. 7a, 7b, 8.

In this configuration the tubular support 2 is constituted by a body 20 made of paper material and by a respective stiffening crown 13, also made of paper material (see in this regard FIG. 9, which illustrates the components before the step of realisation).

In particular, the body 20 is defined by a flat strip destined to be placed in a tubular configuration to define the lateral wall 5.

Again, as can be seen from FIG. 9, a plurality of teeth 14 are also present which are intended to be fashioned along the transversal direction and bent outwards once the body 20 is shaped into a tubular configuration (see FIG. 7b).

In particular, the body 20 defines the lateral wall 5 and a plurality of teeth 14 emerging radially from the lateral wall, while the stiffening crown 13 made in a separate body and unremovably coupled to the body 20 is placed exactly at the teeth 14 in such a way as to be superiorly coupled thereto, thus defining a completely smooth upper surface 6a of the annular crown rigidly fixed to the body 20 by gluing or welding to the teeth 14.

In this way it is possible to realize a tubular support 2 exhibiting a completely smooth lateral wall 5 and also an upper surface 6a of the stiffening crown 13 or the annular crown 6 which is also smooth and optimised for the sealing of the capsule.

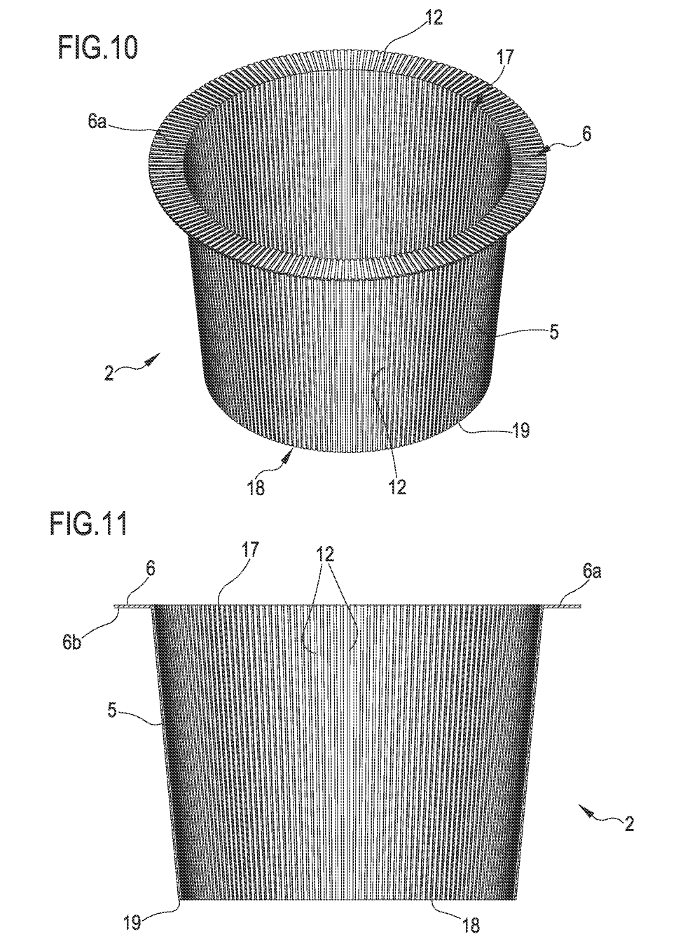

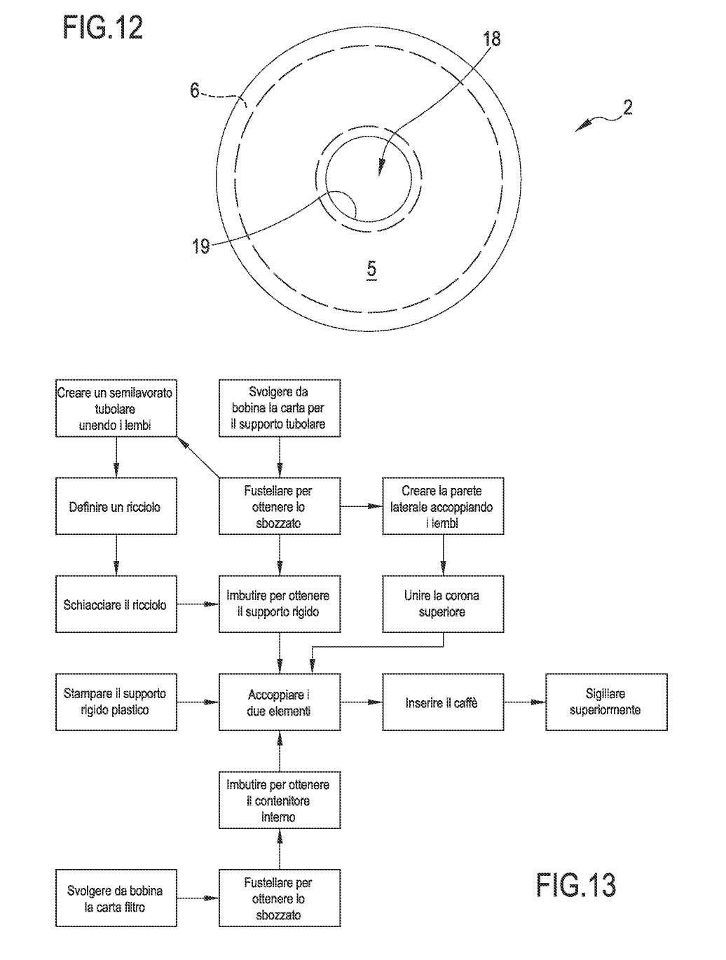

A third embodiment of the tubular support 2 is illustrated in FIGS. 10 and 11 (the starting blank is instead illustrated in FIG. 12).

In this situation the tubular support is realised by means of a deformation operation, for example deep-drawing, from a flat sheet material as illustrated in FIG. 12.

The blank is circular in shape and has a central hole which will define the lower access 18 of the support.

In particular a more internal crown will define the lateral wall 5, while the more external crown will define the annular crown 6.

Obviously, in this configuration, bringing a blank from the flat configuration to the three-dimensional configuration will generate a predetermined number of pleats 12 defined by an excess of paper material.

A further very advantageous variant of the tubular support 2 includes realising the support 2 from a flat blank 100 having a shape similar to a circular sector.

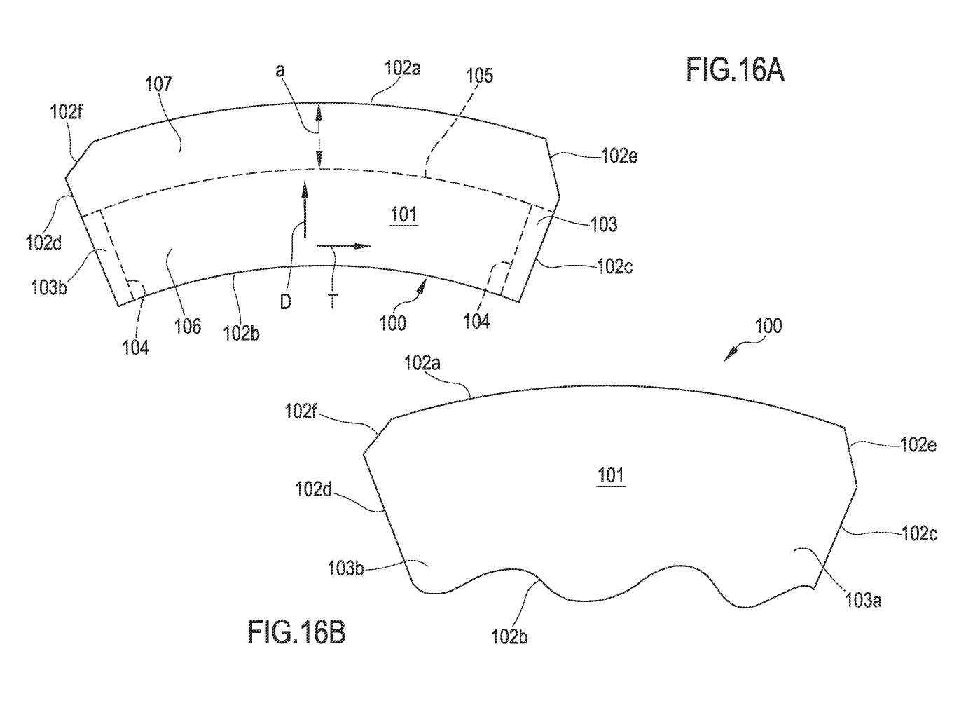

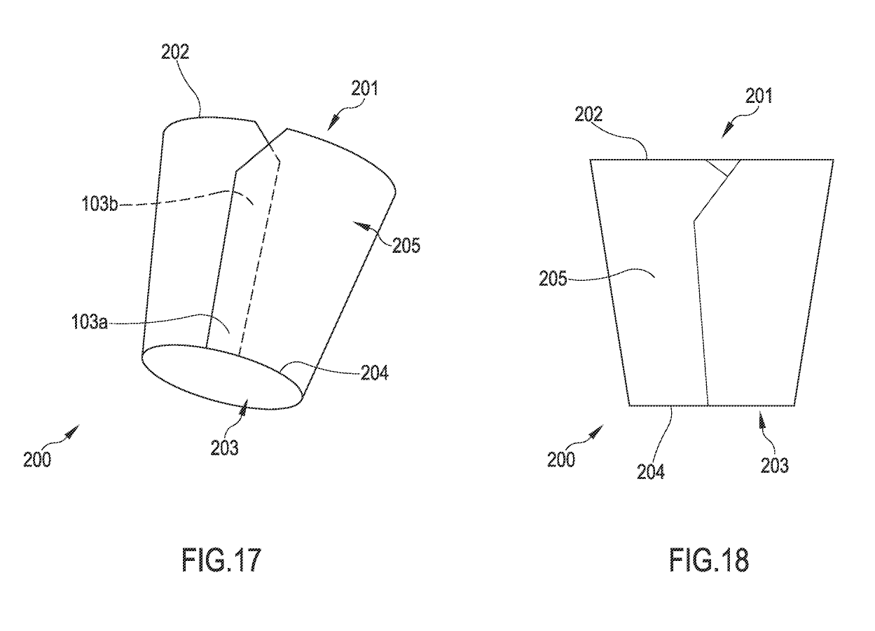

In particular the blank is illustrated in FIGS. 16a and 16b and the subsequent production steps of the tubular support 2 are illustrated in FIGS. 17 to 20.

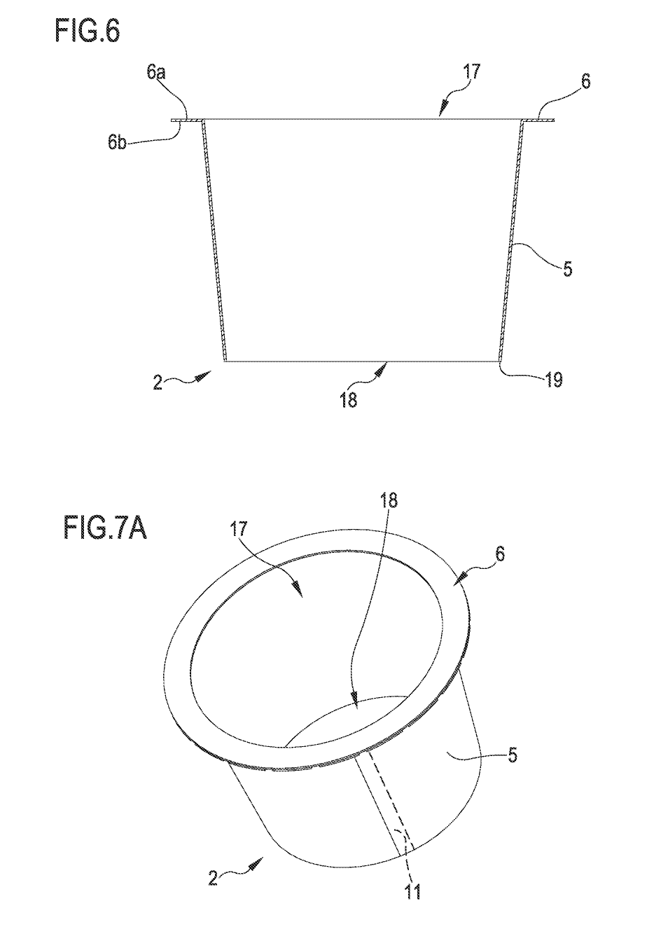

Returning to the image of FIG. 6a and FIG. 16b, it can be seen that the blank 100 made of paper material exhibits a central body 101 defined by a plurality of consecutive sides 102a, 102b, 102c, 102d, 102e and 102f.

In particular there are two opposite sides 102a and 102b (generally, but not necessarily larger sides) that will delimit the subsequent stage of deformation of an upper opening 201 and a lower opening 203 of a tubular semi-finished piece 200.

In general, and as better clarified in the following, the side 102a is intended to define the free upper edge 102 of the semi-finished piece 200, will be defined by a curved profile with its concavity facing the interior of the body 101.

In particular, the curved profile will generally be circular with the centre of the radius of curvature external of the body 101.

Conversely, the opposite side 102b will be destined to define the free lower edge 204 of the semi-finished product 200.

In the embodiment of FIG. 16a the side 102b is also defined by a curved profile having a concavity thereof facing externally of the body 101.

In this case too the profile of the side 102 is circular in shape with centre of curvature that can coincide with the centre of curvature of the other side 102a.

Note also the presence of two opposite sides 102c and 102d that in the three-dimensional semi-finished piece 200 will be neared to one another.

In particular both the side 102c, and the side 102d emerge directly from the lower side 102b and are then connected to the opposite upper side 102a via respective connecting sides 102e, 102f, generally having a smaller development and able to define the absences of material in proximity of the upper zone 107 of the body 101; these connecting sides 102e, 102f are reasons for the reasons clarified herein below.

From a comparison of FIGS. 16a and 16b it can be seen that in general the side 102b, destined to define the free lower edge 204, can have any shape.

Also sides 102c, 102d, 102e, 102f can assume different shapes from those represented as long as they enable realising a tubular blank 200 of truncoconical section.

In general, the blank 100 shown in the figures previously described is made from extensible paper, or a paper able to present elongations in predetermined directions of at least 5% or higher.

In general, the extensible paper used has elongations of greater than 8% and different depending on the direction in which they are measured (in other words the paper has an anisotropic behaviour in terms of elongation).

In general, the paper has a preferred direction D, which allows the maximum elongation.

In this direction the elongation is at least 10% and generally higher than 13%, even up to 15%.

In the transversal direction T, perpendicular to the direction of maximum elongation, the extensible paper is still able to ensure an extension of at least 8% and in particular at least 10%.

As can be seen from the representation of FIG. 16a, the direction D of maximum extensibility of the paper is transversal and substantially perpendicular to the side 102a of the blank intended to define the free upper edge 202 of the semi-finished product 200.

In the blank of FIG. 16a two lateral portions 103a, 103b are also identified, which are destined to be superimposed and coupled when the tubular semi-finished piece 200 is realised and the tubular support 2 finished.

The coupling can be obtained by welding (for example, heat-welding of film present on the plastic material) or also by gluing or similar technologies.

Still with reference to the blank of FIG. 16a, two portions of the body 101 are also highlighted, a first portion 106 arranged below and bounded by the side 102b, the other portion 107 arranged above and adjacent to the previous portion 106 and bounded by the side 102a.

The first lower portion 106 will be used to define the lateral wall 5 of the tubular support 2, while the second upper portion 107 is instead destined to define the annular crown 6 of the tubular support 2.

Once the blank 100 has been defined, the construction steps of the tubular support 2 subsequently comprise three-dimensionally deforming the blank in order to fashion the above-mentioned tubular blank 200 which exhibits the two lateral portions 103a and 103b neared to one another.

The blank 200 is illustrated in FIGS. 17 and 18.

The blank exhibits a tubular through-conduit which extends between an opening 201 delimited by an upper free edge 202 corresponding to one of the sides 102a of the initial blank 100.

The tubular conduit inferiorly exhibits a lower opening 203 delimited by a free lower edge 204 corresponding to a further side 102b of the sides of the initial blank 100.

The two lateral portions 103a and 103b are unremovably constrained to one another in such a way that the tubular blank 200 retains its truncoconical shape.

In general the entire body 101 will define the lateral wall 205 of the semi-finished product 200.

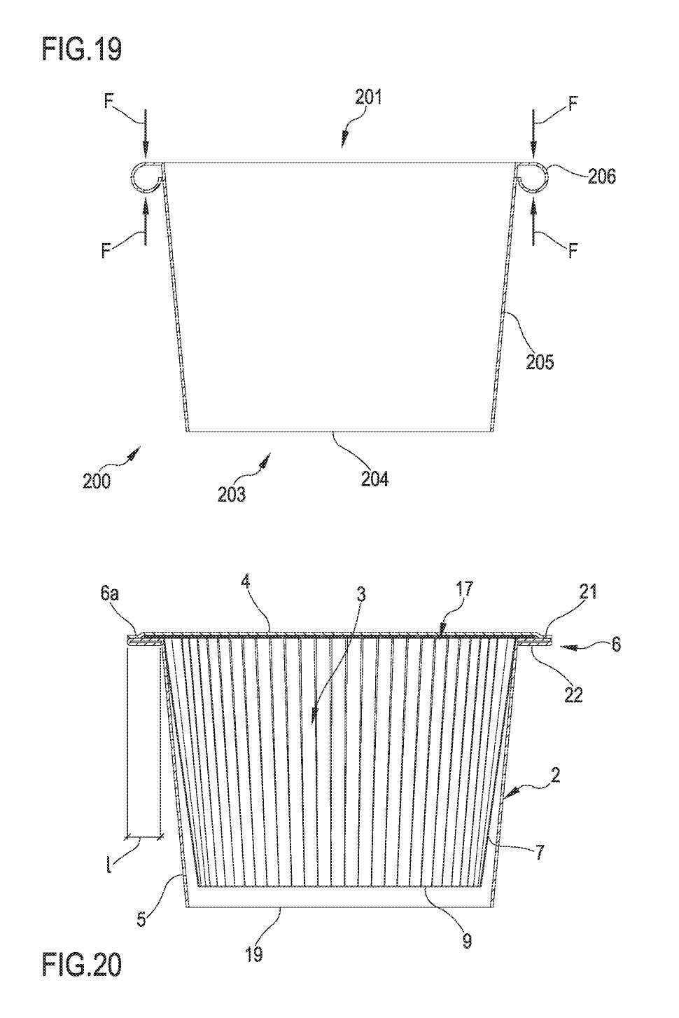

At this point the blank 200 is deformed, bending the upper edge 202 towards the outside in such a way as to progressively define a curl 206 of the type shown in FIG. 19.

In other words, the material that had defined the upper portion 107 of the blank 100 is folded towards the outside of the tubular blank and goes to define the surface of the curl 206 illustrated in FIG. 19.

This actually reduces the height of the tubular blank 200 by a value corresponding to the distance shown in FIG. 16.

The curl 206 completely surrounds the upper opening 17 of the tubular support, effectively embracing the support.

Returning to FIG. 18, the superposing of the lateral cutaways delimited by the edges 102e and 102f can be observed, which serve to prevent superposing of material occurring at the upper edge of the tubular semi-finished piece 200, which superposing takes place in the join zone where the curl 206 is to be realised.

In fact this material, if doubled, makes curling operations relating to the curl difficult.

In general the distance a of FIG. 16a, or in any case the externalwise folding of the curl, is determined by using a quantity of material that is such as to enable defining an annular crown 6 of appropriate dimensions.

In fact, following the folding of the curl 206 a subsequent step of crushing is performed, by applying the appropriate directional forces according to the arrows F shown in FIG. 19.

In this way the curl 206 is crushed, defining the flat annular crown 6 of the finished tubular support.

In general, the annular crown 6 will include an upper wall 21 and a lower wall 22 folded on one another, but made in a single piece.

In particular, the lower wall 22 will be folded back under the top wall 21 as shown in FIG. 20.

In general, the upper surface 6a of the annular crown 6 will be perfectly smooth and free not only of pleats, but also of small crepe-like folds or irregularities that can compromise the sealing of the cavity by the closing element 4.

It should be noted that the use of stretchable paper enables obtaining widths of the annular crown 6 (see FIG. 20) of at least 3 mm and in the detail of at least 4 mm, at the same time enabling a perfectly smooth upper surface 6a to be obtained without any breakage and an annular ring of sufficient size to allow the engagement and sealing of a closing element 4.

Lastly, FIG. 20 shows the overall capsule assembly for the preparation of beverages which uses the tubular support 2 obtained with the method described above.

All other elements appear to be the same as described in this application and have been identified with the same reference numerals.

The tubular support 2, in any of the embodiments described above, and the filter container 3 are therefore coupled together by superposing the respective upper crown 8 on the annular crown 6, possibly by welding or by gluing them together.

In particular, the coupling configuration illustrated in FIG. 4 and further detailed in FIG. 4a shows how the lower opening 18 of the tubular support 2 exhibits general dimensions similar to the dimensions of the base 9 of the filter container 3.

In the embodiment of FIG. 4 the filter container 3 is completely housed in the tubular support 2.

It is however clear that in alternative embodiments a filter container 3 such as the one described could partially emerge from the lower free edge 19 of the tubular support or can be very retracted with respect to the same edge.

Still observing FIGS. 4 and 4a it can be observed that in the reciprocal engaging condition, the lateral wall 5 of the tubular support 2 and the lateral wall 7 of the filter container develop adjacent and in particular they are substantially in contact at the position of the opening 17 of the tubular support 2.

In general, the geometries of the two containers will be such that the lateral wall 7 of the filter container moves away from the lateral wall 5 of the tubular support 3, gradually from the upper opening 17 towards the lower opening 18.

This different inclination of the lateral walls creates a gradually increasing gap between the filter container 3 and the tubular support 2, which facilitates the outflow of liquid toward the lower opening 18 of the tubular support.

Note how the closing element 4 can be a film engaged to the filter container 3 and/or to the tubular support 2 in order to close the upper access of the filter container and/or the upper opening 17 of the tubular support such as to prevent exit of the substance contained from the housing compartment.

In particular observing FIG. 4a, the film 4 is welded both to the upper crown 8 of the filter container 3 and to the annular crown 6 of the tubular support 2 such as to define a substantially hermetic closure of the capsule.

Note also that the closing element 4 can be made of a biodegradable material; should this not be paper material it could be a biodegradable plastic such as the one commercially known as “MATER-BI” manufactured by the Novamont company.

The production process of the capsule described above is illustrated in the block diagram of FIG. 13.

The tubular support 2 can be alternatively moulded plastic or paper material unwound from a reel and punched out to obtain the appropriate blank.

Depending on whether the embodiment is in a single piece, it is deep drawn to obtain the rigid support.

Alternatively the lateral wall and the upper crown are created separately; the lateral wall is appropriately configured three-dimensionally by coupling the respective longitudinal edges to define the closing strip 11 and the upper stiffening ring 13 is then joined.

In a further alternative, the support 2 is obtained according to the process illustrated in FIGS. 16-19.

The filter paper is at the same time unreeled and punched to obtain the appropriate blank and then deep-drawn to obtain the inner container.

At this point the two elements are unremovably coupled to one another, the desired foodstuff (for example coffee) is inserted into the housing compartment 16 and the upper opening 17 of the tubular support is sealed superiorly with the closing film 4 (or the element made, for example, of paper) such as to obtain a container of the type illustrated in FIG. 1.

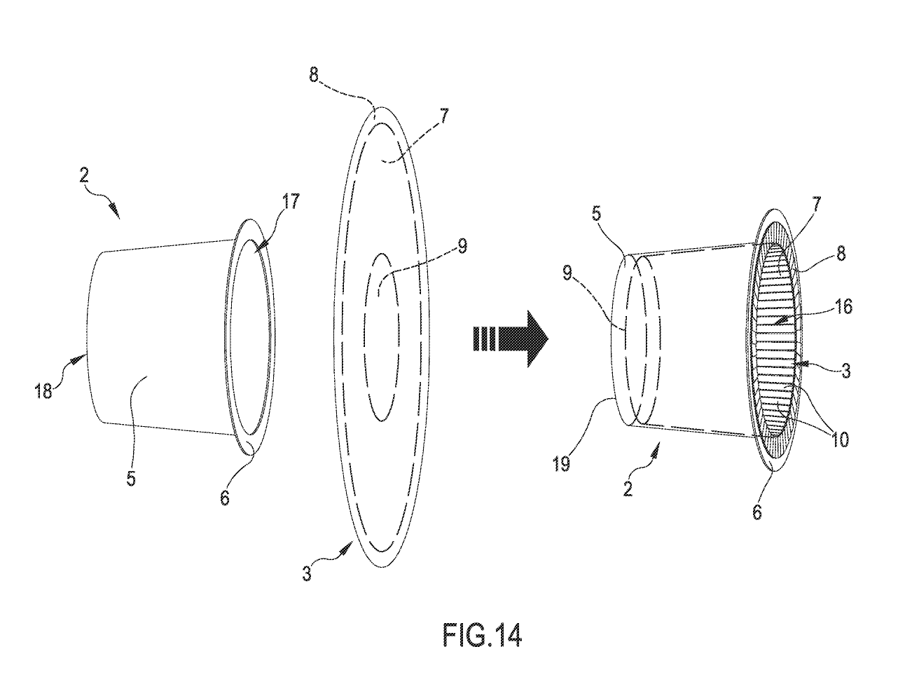

Note that advantageously, and as shown in FIG. 14, the steps of realization by deep drawing of the filter container 3 and coupling the container 3 with the tubular support 2 can be carried out in the same single step.

In this situation the filter container 3 is deformed inside the tubular support 2 starting from the flat blank as illustrated in FIG. 14.

The above allows you to save a station of a production step with significant advantages.

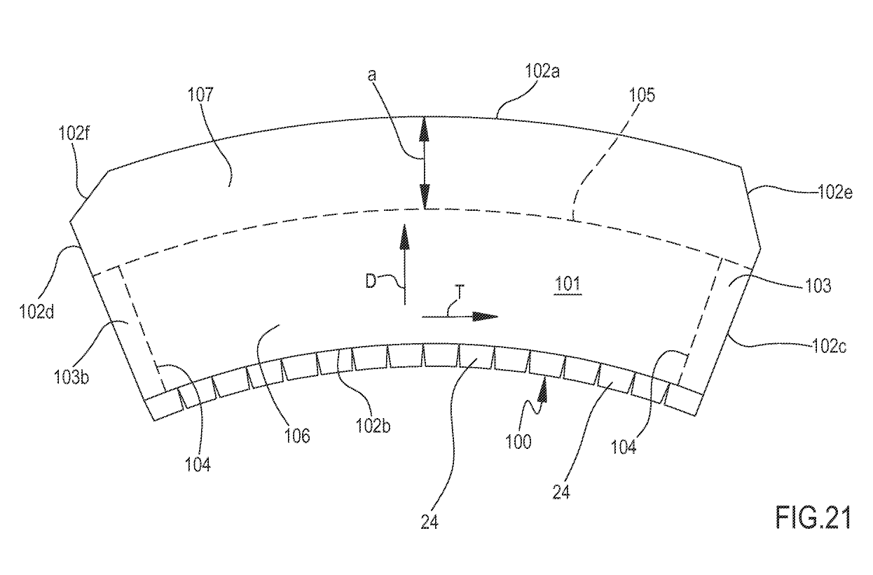

In a further embodiment (FIGS. 21-25) the support 2 is inferiorly closed by a base 23.

In particular the manufacturing steps might start form a flat blank 100 identical to the one previously described (FIG. 16a) in which teethes 24 are linked in correspondence of the side 102b.

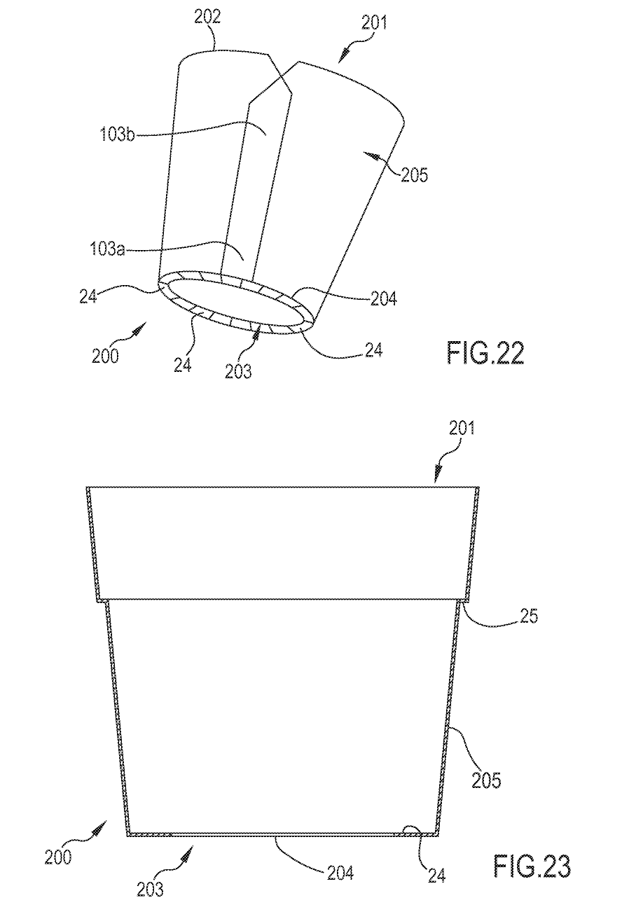

these teethes are folded inside the support cavity as in FIG. 22 and a base, in particular a circular base, e.g. made of paper material, is inferiorly attached to the teethes 24 to close the inferior volume of the support (FIG. 23).

In other terms, also the manufacturing process is substantially the same as previously described since the only additional steps are the provision of the cited teethes and their inner folding and the coupling of the inferior paper base 23 to close the lower opening.

It is apparent that any of the other tubular support embodiments previously described might be closed by a base 23.

Furthermore any of the support embodiments may further comprise an undercut 25 particularly obtained by plastic deformation of the support, placed in correspondence of the upper opening and developing circumferentially along the whole circular perimeter of the lateral wall (see FIGS. 23-25).

The undercut may be realized particularly thanks to the use of the extensible paper allowing to push towards the outside the upper portion of the lateral wall.

As to the filter container 3, the same may be coupled to the closed support of FIGS. 21-25 as previously described, e.g. using its upper crown 8, or may vice versa only applied to the upper portion of the lateral wall without influencing the upper crown 6 of the support 2 as shown in FIG. 25.

The embodiments achieve important advantages.

Firstly a capsule for foodstuff drinks is provided that is entirely biodegradable so that it can be entirely recycled without the need for separating the various components from one another.

The capsule can be realized with only a few simple manufacturing steps and does not incur a higher cost than similar capsules currently on the market.

From the production point of view the number of coupling steps can be reduced, while still obtaining a container suitable for the objective, which container can be sealed without any particular drawbacks.

Finally it should be noted that the realisation of a tubular support 2 made of paper material, as well as the use of coating film for both the tubular support 2 made of paper material and for the closing element, which latter could be constituted solely by a film or also from a paper material inferiorly clad with the film, as well as the use of a filter container 3 made entirely of filter paper, mean that a capsule can be made that is entirely biodegradable as required by current European standard EN 13432 and American standard ASTM D6400, and by ISO 17 088 standard currently at the approval stage.

1. A process of making a capsule for preparation of drinks including a support (2) made of a paper material, the process comprising following steps:
predisposing a flat blank (100) of paper material having a body (101) delimited by a plurality of sides (102a), (102b), (102c), (102d), (102e), (102f) and exhibiting two opposite lateral portions (103a), (103b), each located at a respective side (102c), (102d);
three-dimensionally deforming the flat blank to define a tubular semi-finished workpiece (200) exhibiting the two lateral portions (103a), (103b) neared to one another; the tubular semi-finished workpiece (200) exhibiting a tubular conduit which extends between an upper opening (201) delimited by a free upper edge (202) corresponding to a side (102a) of the sides of the blank (100) and a lower opening (203) delimited by a lower free edge (204) corresponding to a further side (102b) of the sides of the blank (100);
coupling the two lateral portions to one another, the body (101) defining a lateral wall (205) of the tubular semi-finished workpiece (200);
deforming the free upper edge (202) towards the outside of the upper opening (201) to define a curl (206) which extends perimetrally about the upper opening (201) of the semi-finished workpiece (200);
crushing the curl (206) in a plane to define an annular crown (6) which radially emerges from an upper opening (17) of the support (2), the annular crown (6) exhibiting an upper surface (6a) that is flat, smooth and free of pleats;
predisposing a filter container (3) exhibiting a base and a lateral wall (7) emerging distancingly from the base (9), the filter container (3) exhibiting an upper access and defining a housing compartment (16) being made of a material at least partially permeable to a liquid;
coupling the filter container to the support;
introducing in the housing compartment a predetermined quantity of a substance (15) for releasing an aroma for preparing a drink when crossed by a liquid, and
closing the upper access of the filter container (3) and/or the upper opening (17) of the support to prevent exit of the material contained in the housing compartment (16) by means of a closing layer (4) engaged to the filter container (3) and/or the support (2).

2. The process of the preceding claim 1, wherein the step of predisposing the blank (100) comprises a sub-step of predisposing a blank made of stretchable paper having a stretchability in a prefixed direction (D) by at least 10%, and in the perpendicular direction (T) to the direction (D) by at least 10%.

3. The process of claim 1, wherein the step of predisposing the blank (100) comprises a step of defining a direction of maximum stretchability (D) of the paper in a transversal direction that is substantially perpendicular to the side (102a) of the blank destined to define the free upper edge (202) of the semi-finished workpiece (200).

4. The process of claim 1, wherein the body of the blank (100) is delimited by four main sides (102a), (102b), (102c), (102d), the side (102a) defining in use the free upper side (202) of the semi-finished workpiece (200) having a curved profile with a concavity facing towards the inside of the body (101).

5. The process of claim 1, wherein the step of deforming the free upper edge (202) for deforming a curl (206) comprises a fold towards an outside by a quantity of material to enable defining an annular crown (6) having a breadth (1) of the free upper surface (6a) which is at least 3 mm.

6. The process of claim 1, wherein the definition of the annular crown (6) comprises defining an upper wall (21) and a lower wall (22) folded below the upper wall, the two walls (21, 22) being defined in a single piece.

7. The process of claim 1, wherein the support includes a base made of paper material to close an inferior aperture of the support, the filter container being not accessible in an assembled condition of the capsule.

8. The process of claim 7, wherein the support includes a plurality of teethes emerging transversely from the lower edge of the lateral wall and attached to the base.

9. The process of claim 1, including the step of deforming the lateral wall to define at least an undercut developing along a circular development of the lateral wall, the undercut being in correspondence of an upper side of the lateral wall.

10. The process of claim 1, wherein the support and the filter container are joined in correspondence of an upper portion of the lateral wall of the support.

11. The process of claim 1, wherein the support and the filter container are joined in correspondence of the annular crown of the support.

12. A capsule for preparing drinks such as coffee or the like, comprising:
a filter container (3) exhibiting a base and a lateral wall (7) emerging distancingly from the base (9), the filter container (3) exhibiting an upper access and defining a housing compartment (16) being made of a material that is at least partially permeable to a liquid;
at least a support (2) of the type obtained with the process of claim 1, exhibiting a tubular conduit which extends between an upper opening (17) and a lower opening (18), the filter container (3) being housed at least in part internally of the tubular conduit, in coupling conditions between the filter container and the tubular support (2), the filter container receiving and retaining, in the housing compartment, the material in inlet through the upper opening (17) of the tubular support;
a predetermined quantity of a substance (15) suitable for releasing an aroma for preparing a drink when crossed by a liquid, the substance (15) being housed in the housing compartment (16), and
a closing film (4) engaged to the filter container (3) and/or the tubular support (2) for closing the upper access of the filter container (3) and/or the upper opening (17) of the tubular support such as to prevent exit of the material contained in the housing compartment (16).

13. The capsule of claim 12, wherein the tubular support (2) exhibits, at the upper opening (17), an annular crown (6) emerging distancingly from a lateral wall (5) in a radially external direction with respect to the tubular conduit delimited by the upper opening (17) and the lower opening (18), the annular crown (6) exhibiting an upper surface (6a) that is substantially flat.

14. The capsule of claim 12, wherein the support (2) exhibits a cylindrical symmetry, the upper opening (17) being circular and the lower opening (17) being circular, the upper opening (17) having a greater area than the areas of the lower opening (18), the diameter of the upper opening (17) being greater than the diameter of the lower opening (18), the tubular support (2) exhibiting a lateral wall (5) conformed as a truncated cone having a decreasing section starting from the upper opening (17) towards the lower opening (18).

15. The capsule of claim 12, wherein the support includes a base made of paper to close the second opening 18, the base being fixed to a lower portion of the lateral wall.

16. The capsule as in claim 12, wherein the lower opening (18) of the tubular support (2) exhibits dimensions alike to the dimensions of the base (9) of the filter container (3).

17. The capsule as in claim 12, wherein, in a condition of reciprocal engagement, a lateral wall (5) of the tubular support (2) and the lateral wall (7) of the filter container (3) develop adjacently, the lateral wall (7) of the filter container (3) being in contact with the lateral wall (5) of the tubular support (2) at the upper opening (17) thereof, the lateral wall (7) of the filter container (3) distancing from the lateral wall (5) of the tubular support (3), as it progresses from the upper opening (17) towards the lower opening (18).

18. The capsule as in claim 12, wherein the tubular support (2) exhibits a closing strip (11) developing along the lateral wall (5) from the upper opening (17) to the lower opening (18).

19. The capsule as in claim 12, wherein the closing element (4) is a film made of a bio-degradable plastic or is a body made of a paper material coated, at least on the coupling surface to the tubular support (2), with bio-degradable plastic, the closing element (4) being coupled by welding and sealedly to the annular crown (6) of the tubular support (2) and/or to the upper crown (8) of the filter container (3).

20. The capsule as in claim 12, wherein the lateral wall of the support includes an undercut placed in correspondence of an upper side of the lateral wall.
